(19) United States
(12) Patent Application Publication
(10) Pub. No.: US 2009/0034073 A1
(43) Pub. Date: Feb. 5, 2009

(54) Multilayer Polarizer

(75) Inventor: Pavel I. Lazarev, London (GB)

Correspondence Address: HOUST CONSULTING, P.O. BOX 2688, SARATOGA, CA, 95070-0688, US

(73) Assignee: CRYSOPTIX KK, Tokyo (JP)

(21) Appl. No.: 12/161,611

(22) PCT Filed: Jan. 23, 2007
(86) PCT No.: PCT/GB2007/000225

§ 371 Date: Jul. 21, 2008

(30) Foreign Application Priority Data
Jan. 23, 2006 (GB) GB 0601283.5
Jan. 23, 2007 (GB) PCT/GB2007/000225

(51) Int. Cl. G02B 5/30

(52) U.S. Cl. 359/498

(57) ABSTRACT

The present invention relates generally to the field of multilayer polarizer, in particular, to the polarizer designed to polarize selected wavelengths of light by optical interference and reflectance. The multilayer polarizer comprises a plurality of layers located on the substrate. The layers and the substrate are transparent in at least one predetermined wavelength subrange of the wavelength band in the range from 200 to 2500 nm. The layers are arranged in such a way that a light of first polarization is substantially reflected while a light of second polarization is substantially transmitted through the multilayer polarizer. At least one of said layers is formed by rod-like supramolecules that at least partially form a three-dimensional structure in the layer.

The present invention relates generally to the field of multilayer polarizers, in particular, to multilayer polarizers designed to polarize selected wavelengths of light by optical interference and reflectance.

Multilayer polarizers with birefringent layers are generally known in the art and have been used in the past to polarize and filter selected wavelengths of light. For example, multilayer polarizers may be used to reject (reflect) specific polarized narrow wavelength ranges while transmitting the remainder of the incident light, to reduce glare from other light sources, and to act as beam splitters.

Many naturally occurring crystalline compounds have biaxial properties. For example, calcite (calcium carbonate) crystals have well known biaxial properties. However, single crystals are expensive materials and cannot be readily formed into the desired shapes or configurations which are required for particular applications. Others in the art have fabricated birefringent polarizers from plate-like or sheet-like birefringent polymers such as polyethylene terephthalate incorporated into an isotropic matrix polymer.

In many instances, polymers can be oriented by uniaxial stretching to orient the polymer on a molecular level. In the art there are also the multilayer optical devices comprising alternating layers of highly birefringent polymers and isotropic polymers having large differences of refractive indices.

However, this device requires the use of specific highly birefringent polymers having certain mathematical relationships between their molecular configurations and electron density distributions.

Accordingly, there remains a need in the art for multilayer polarizers which can be readily produced using existing techniques and readily available materials. There still exists a need in the art for biaxial multilayer polarizers which absorb little light. And further, the need exists in the art for multilayer biaxial polarizers which can be fabricated to polarize light of specific wavelengths as desired.

The present invention provides multilayer polarizers comprising a substrate and a plurality of layers located on the substrate. Said substrate and layers are transparent in at least one predetermined wavelength subrange of the wavelength band in the range from 200 to 2500 nm. The layers are arranged in such a way that a light of first polarization is substantially reflected while a light of second polarization is substantially transmitted through the multilayer polarizer. At least one of said layers is formed by rod-like supramolecules, which are capable of forming a three-dimensional structure in the layer.

The general description of the present invention having been made, a further understanding can be obtained by reference to the specific preferred embodiments, which are given herein only for the purpose of illustration and are not intended to limit the scope of the appended claims.

Thus, the present invention provides a multilayer polarizer comprising a plurality of layers located on the substrate. The layers and the substrate are transparent in at least one predetermined wavelength subrange of the wavelength range from 200 to 2500 nm. The layers are arranged in such a way that a light of first polarization is substantially reflected while a light of second polarization is substantially transmitted through the multilayer polarizer; the second polarization is substantially normal to the first polarization. At least one of said layers is formed by rod-like supramolecules, which form at least a partial three-dimensional structure in the layer.

The supramolecule is an association of flat p-conjugated molecules in a stack with the number of molecules in association defined by conditions of formation such as temperature, pressure, additives and so forth and not being precisely and definitively controlled by the molecules' structure or the composition of functional groups.

In a preferred embodiment of the present invention, the rod-like supramolecules are formed by at least one polycyclic organic compound with a conjugated π-system and functional groups which are capable of forming non-covalent bonds between said supramolecules. Functional groups of one molecule are designed in such a way that they may interact with each other with formation of inter-stack non-covalent bonding, forming a fully saturated three dimensional network of non-covalent bonds. The plurality of layers and the substrate can be transparent for electromagnetic radiation only in a part of the wavelength range from 200 to 2500 nm, rather than in the entire range, and this part of said wavelength band will be called a subrange. This subrange can be determined experimentally for each polycyclic organic compound with a conjugated π-system and functional groups.

In still another preferred embodiment of the present invention, the molecules of at least one organic compound comprise heterocycles. In yet another preferred embodiment of the present invention, at least one of said layers is water non-soluble. The combination of functional groups of one molecule is designed in such a way that the network of non-covalent bonds inhibits inclusion of water in the three-dimensional structure of the crystalline structure of molecules being parts of supramolecules.

In another preferred embodiment of the present invention, at least one of said layers is optically biaxial. In still another preferred embodiment of multilayer polarizer, at least one of said layers is optically uniaxial.

In another preferred embodiment of the present invention, the rod-like supramolecules are oriented substantially parallel or perpendicular to the substrate surface. In still another preferred embodiment of the present invention, at least one of the non-covalent bonds is an H-bond. In yet another preferred embodiment of the present invention, at least one of the non-covalent bonds is a coordination bond.

In one embodiment of the multilayer polarizer, the organic compound has the general structural formula I

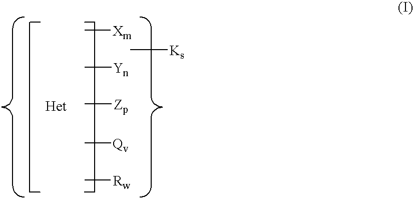

where Het is a planar conjugated heterocyclic molecular system; X is a carboxylic group —COOH; m is 0, 1, 2, 3 or 4; Y is a sulfonic group —SO₃H; n is 0, 1, 2, 3 or 4; Z is an amide of a carboxylic acid group; p is 0, 1, 2, 3 or 4; Q is an amide of a sulfonic acid group; v is 0, 1, 2, 3 or 4; K is a counterion; s is the number of counterions providing neutral state of the molecule; R is a substituent selected from the list comprising CH₃, C₂H₅, NO₂, Cl, Br, F, CF₃, CN, OH, OCH₃, OC₂H₅, OCOCH₃, OCN, SCN, NH₂, and NHCOCH₃; w is 0, 1, 2, 3 or 4; and if the integer m is equal to 0, then both n and p are not equal to 0, and if the integer n is equal to 0, then the integer m is equal to or greater than 1. Preferably, K is selected from the list comprising H⁺, NH₄⁺, Na⁺, K⁺, Li⁺, Ba⁺⁺, Ca⁺⁺, Mg⁺⁺, Sr⁺⁺, Zn⁺⁺.

Preferably, Het has the general structural formula (II):

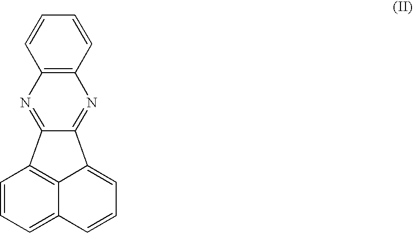

or the general structural formula (III):

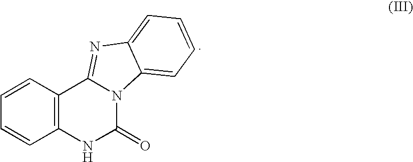

In one preferred embodiment of the disclosed multilayer polarizer, the organic compound is an acenaphthoquinoxaline derivative. Examples of the acenaphthoquinoxaline sulfonamide derivatives containing carboxylic groups and having general structural formulas corresponding to structures 1-7 are given in Table 1.

TABLE 1
Examples of acenaphthoquinoxaline sulfonamide derivatives
containing carboxylic groups

| | |
|---|---|
| 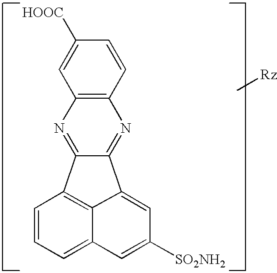 | (1) |
| 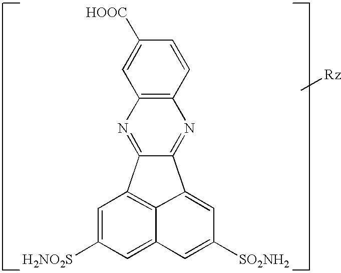 | (2) |
| 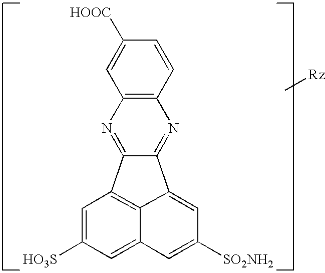 | (3) |
| 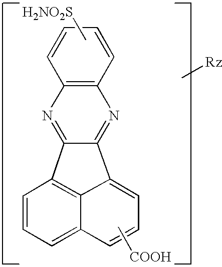 | (4) |
| 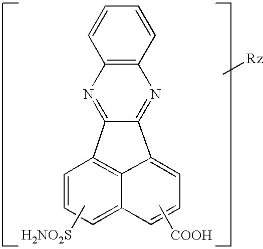 | (5) |
| 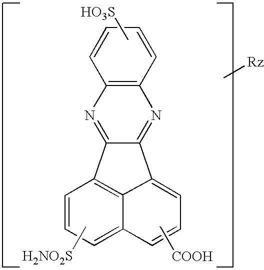 | (6) |
| 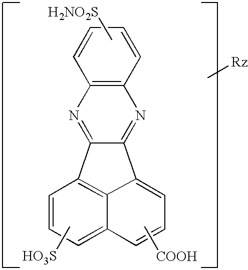 | (7) |

In another embodiment of the disclosed multilayer polarizer, said acid group is a sulfonic group. Examples of the acenaphthoquinoxaline sulfonamide derivative containing sulfonic groups and having general structural formulas corresponding to structures 8-19 are given in Table 2.

TABLE 2
Example of acenaphthoqinoxaline sulfonamide derivatives
containing sulfonic groups

| | |
|---|---|
| 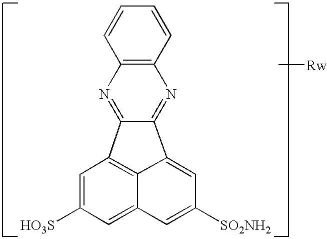 | (8) |
| 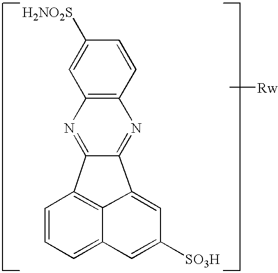 | (9) |
| 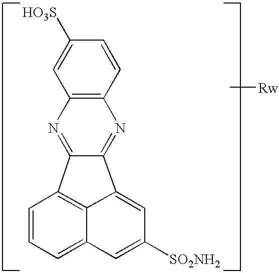 | (10) |
| 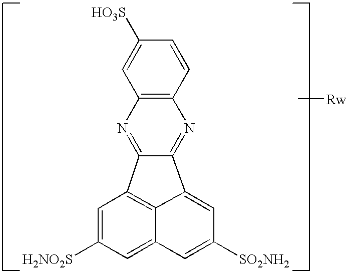 | (11) |
| 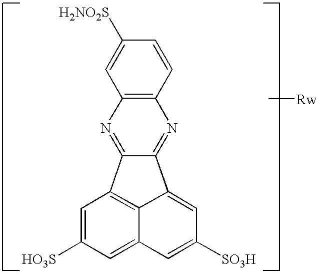 | (12) |
| 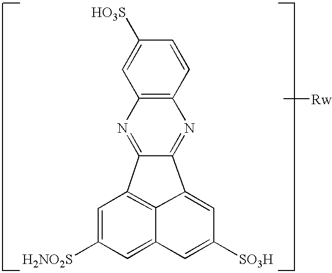 | (13) |
| 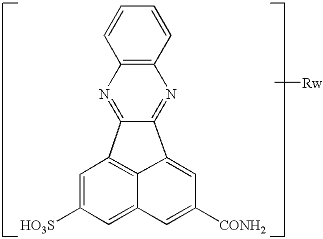 | (14) |
| 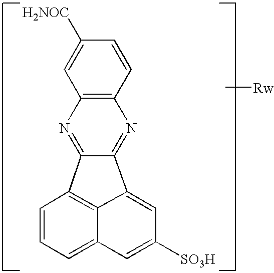 | (15) |
| 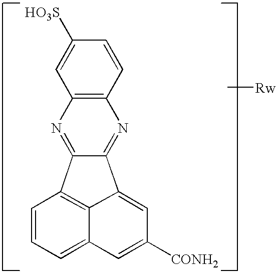 | (16) |
| 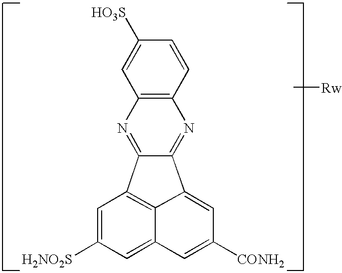 | (17) |
| 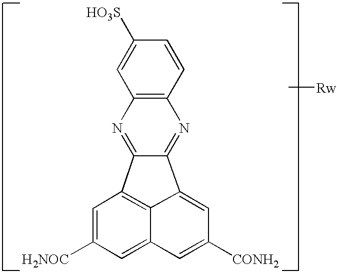 | (18) |
| 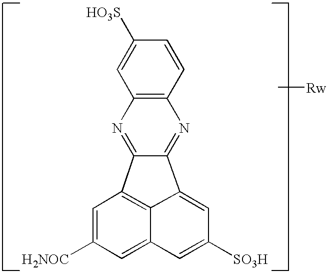 | (19) |

In another preferred embodiment of the multilayer polarizer, the organic compound is a 6,7-dihydrobenzimidazo[1,2-c]quinazolin-6-one derivative having a carboxylic group or an acid amide group as the functional group.

In one preferred embodiment of the disclosed multilayer polarizer, the 6,7-dihydrobenzimidazo[1,2-c]quinazolin-6-one derivative has at least one carboxyamide group (CONH₂) as the acid amide group. In another preferred embodiment of the disclosed multilayer polarizer, the 6,7-dihydrobenzimidazo[1,2-c]quinazolin-6-one derivative has at least one sulfonamide group (SO₂NH₂) as the acid amide group. Examples of 6,7-dihydrobenzimidazo[1,2-c]quinazolin-6-one derivatives comprising at least one carboxylic group —COOH, wherein the integer m is 1, 2 or 3 and said derivative has the general structural formula from the group comprising structures 20 to 32, are given in Table 3.

TABLE 3
Examples of 6,7-dihydrobenzimidazo[1,2-c]quinazolin-6-one
derivatives containing carboxylic groups

| | |
|---|---|
| 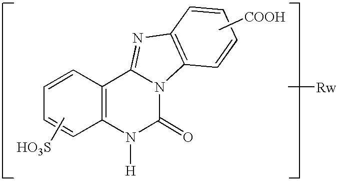 | (20) |
| 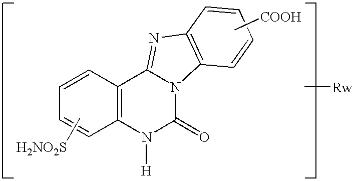 | (21) |
| 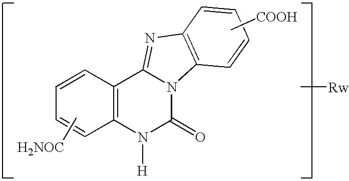 | (22) |
| 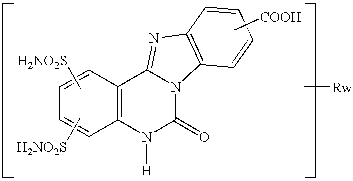 | (23) |
| 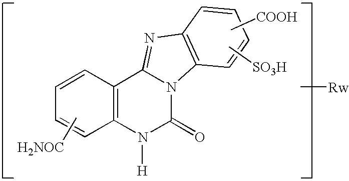 | (24) |
| 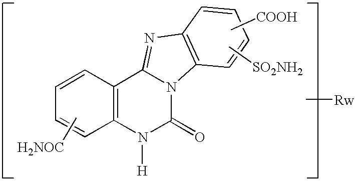 | (25) |
| 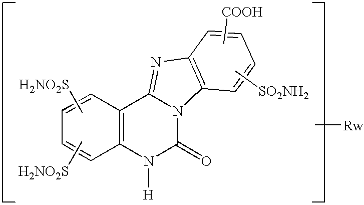 | (26) |
| 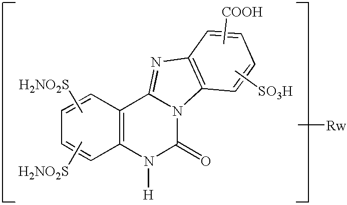 | (27) |
| 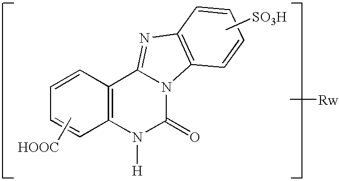 | (28) |
| 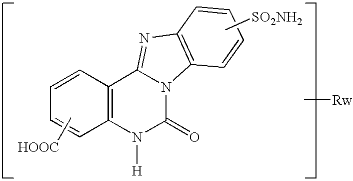 | (29) |
| 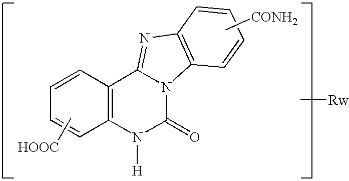 | (30) |
| 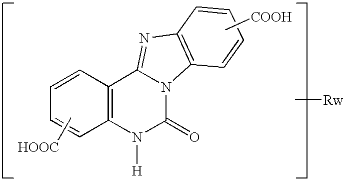 | (31) |
| 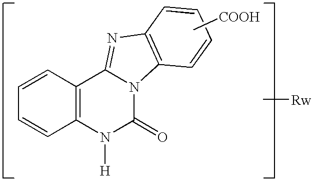 | (32) |

In another preferred embodiment of the disclosed multilayer polarizer, the 6,7-dihydrobenzimidazo[1,2-c]quinazolin-6-one derivative comprises at least one said sulfonic group —SO₃H as the acid group. Examples of the 6,7-dihydrobenzimidazo[1,2-c]quinazolin-6-one derivatives comprising sulfonic groups —SO₃H, wherein integer n is 1, 2 or 3 and said derivative has the general structural formula from the list comprising structures 33 to 41, are given in Table 4.

TABLE 4
Example of 6,7-dihydrobenzimidazo[1,2-c]quinazolin-6-one
derivatives containing sulfonic groups

| | |
|---|---|
| 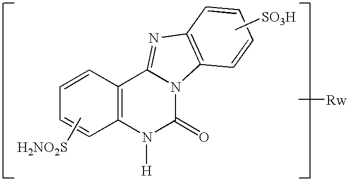 | (33) |
| 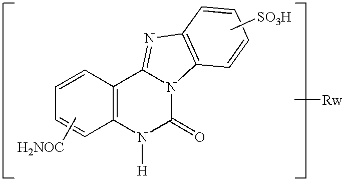 | (34) |
| 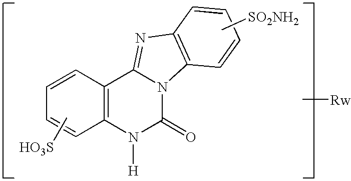 | (35) |
| 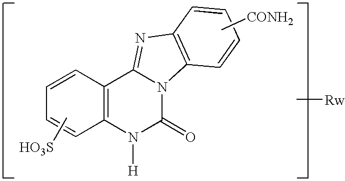 | (36) |
| 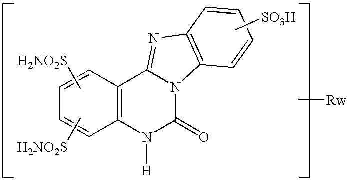 | (37) |
| 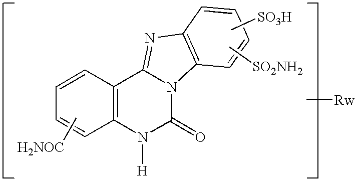 | (38) |
| 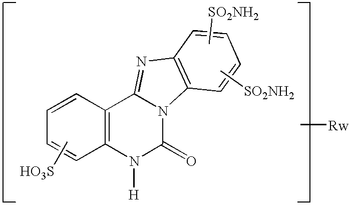 | (39) |
| 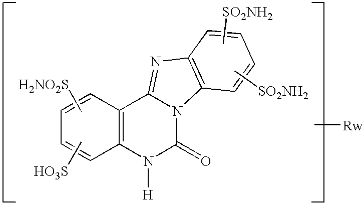 | (40) |
| 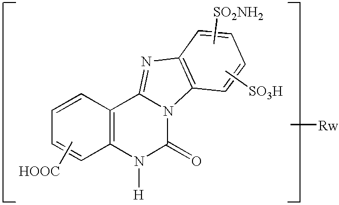 | (41) |

In one preferred embodiment of the disclosed invention, said plurality of layers comprises a stack of alternating optically biaxial and isotropic layers. In another embodiment of the multilayer polarizer, said plurality of layers comprises a stack of alternating optically uniaxial and isotropic layers. In yet another preferred embodiment of the present invention, at least one isotropic layer in the stack comprises at least two sublayers made of materials having different indices of refraction. In still another preferred embodiment of the present invention, the plurality of layers is capable of polarizing light in the entire range of incident angles. In yet another preferred embodiment of the present invention, the total thickness of the plurality of layers does not exceed 5 micrometers, wherein the thickness of each layer is approximately equal to quarter-wave. In another preferred embodiment of the present invention, the total thickness of the plurality of layers does not exceed 3 micrometers, wherein the thickness of each layer is approximately equal to quarter-wave. In another embodiment of the present invention, the number of layers in the plurality of layers does not exceed 20. In another preferred embodiment of the present invention, the number of layers does not exceed 10. In still another embodiment of the present invention, the number of layers does not exceed 5.

In one embodiment of the present invention, the rod-like supramolecules are formed by two or more of said polycyclic organic compounds.

There are three known types of the multilayer lossless polarizers in the art. The polarizer of the first type (see for example U.S. Pat. No. 6,583,930) is an interference polarizer in which the optical thicknesses of adjacent layers in the plurality of layers can be approximately comparable to a quarter of the wavelength of light in the region of the electromagnetic spectrum in which it is intended to operate. The polarizer of the second type (see for example U.S. Pat. Nos. 3,610,729 and 5,122,905) is a reflective polarizer in which the optical thicknesses of adjacent thick layers may exceed several wavelengths. And the third type of multilayer lossless polarizer (see U.S. Pat. No. 5,122,906) is the reflective-interference polarizer, in which thick and thin layers are alternating.

The present invention discloses polarizers of all three main types.

The interference polarizer of the first type is disclosed as an improved optical interference polarizer in the form of a plurality of alternating layers possessing several desirable properties, including the ability to polarize light of selected wavelengths. The basic optical principles of the referenced polarizer of the first type disclosed by the present invention are related to the reflection of light from a stack of thin layers having different refractive indices. According to these principles, the effect depends both on the individual layer thicknesses and on their refractive indices.

Interference polarizers rely on the optical interference of light to produce intense light reflection in the visible, ultraviolet, or infrared regions of the electromagnetic spectrum. Such interference polarizers effectively reflect light according to the equation

λ_{b}=(2/b)·(N₁D₁+N₂D₂), (i)

where λ_{b} is the light wavelength, N₁ and N₂ are the refractive indices of the alternating layers, D₁ and D₂ are the thickness of the corresponding layers, and b is the order of reflection (b is from 1 to 5). This is the equation for light incident along the normal to the surface of the film. For oblique incidence, the equation has to be modified so as to take into account the incidence angle. The polarizer of the present invention is operable for all angles of light incidence.

Each solution of the above equation determines a wavelength for which an intense reflection, relative to surrounding regions, is expected. The intensity of reflection is a function of the ratio f defined as

f=N₁D₁/(N₁D₁+N₂D₂). (ii)

By properly selecting the f value, it is possible to provide for some degree of control over the intensity of reflection for various high-order reflections. For example, first-order reflection of light in the visible wavelength range from violet (about 0.38 μm) to red (about 0.68 μm)) can be obtained with layers possessing optical thicknesses within the range approximately 0.075 to 0.25 μm.

The polarizer of the second type—the disclosed reflective polarizer, is made of multiple alternating thick layers of organic materials differing from each other in refractive index. By properly selecting the materials for adjacent layers, it is possible to provide for a substantial difference of refractive indices in one plane of the polarizer.

The multilayer reflective polarizer of the present invention comprises a system of thick alternating layers, in contrast to the multilayer thin-film interference polarizers mentioned above. The disclosed multilayer reflective polarizers do not display vivid iridescence. In fact, it is important to avoid using layers with thicknesses corresponding to substantial iridescent coloration. By keeping all layers sufficiently thick, high-order reflections are so closely spaced that the human eye perceives the reflection to be essentially silver and non-iridescent.

Multilayer reflective polarizers made in accordance with the present invention exhibit a uniform silvery reflective appearance. The reflection characteristics of the multilayer reflective polarizer of the present invention are governed by the following equation:

Refl=(kr)/[1+(k−1)r]×100% (iii),

where Refl is the amount of reflected light (%), k is the number of thick layers, and

r=[(N₁−N₂)/(N₁+N₂)]².

This equation indicates that the intensity Refl of the reflected light is a function of only r and k defined above. In a close approximation, Refl is a function of only the difference of refractive indices refractive of the two layers and the total number of interfaces between layers. This relationship substantially differs from the case of interferential polarizers whose reflectivity is highly sensitive to the layer thickness and the angle of view.

The wavelength of light reflected from the multilayer reflective polarizer is independent of the individual layer thicknesses and the total structure thickness over a wide range, provided that a substantial majority of the individual layers have an optical thickness equal to or greater than about 0.45 μm. The uniformity of reflection is inherent in the proposed reflective polarizer. Moreover, a gradient of layer thickness across the reflective polarizer structure is neither detrimental nor advantageous to the optical characteristics of the polarizer, provided that a substantial majority of the individual layers have optical thicknesses equal to or greater than about 0.45 μm.

Therefore, it is not essential for all layers in the reflective polarizer of the present invention to have optical thicknesses of 0.45 μm or greater. Visible light passing through this system is polarized within a broad band of wavelengths. The majority of the individual layers have optical thicknesses of at least 0.45 μm or greater. Preferably, the individual layers that make up the multilayer structure are substantially continuous. However, the efficient reflective polarizers may be obtained even with large variations, provided that a substantial majority of the layers have an optical thickness of at least 0.45 μm.

The reflective polarizers according to the present invention exhibit better reflection of the incident light as the number of layers is increased.

The reflectivity of the system also depends on the refractive index difference between the two organic compounds used. That is, the greater the difference in the refractive indices, the higher the reflectivity of the polarizer. Accordingly, it can be seen that the reflective nature of the polarizers may be controlled by selecting organic compounds having substantially different refractive indices and by fabricating systems containing additional layers.

The disclosed reflective-interference of the third type is made of multiple alternating thin and thick layers differing from each other in refractive index. By selecting the polycyclic organic compounds for adjacent layers, it is possible to provide for a substantial difference of refractive indices in one plane of the polarizer. Visible light passing through this system is polarized within a broad band of wavelengths. The majority of the individual layers have optical thicknesses of not greater than 0.09 μm or not less than 0.45 μm. Preferably, the individual layers that make up the multilayer reflective-interference polarizer structure are substantially continuous.

The multilayer reflective-interference polarizer according to the present invention comprises a system of alternating thin and thick layers, in contrast to the multilayer thin-film interference polarizers and to the multilayer thick-film reflective polarizers mentioned above. The disclosed multilayer reflective-interference polarizers do not display vivid iridescence. In fact, it is important to avoid using layers with thicknesses corresponding to substantial iridescent coloration. By keeping the alternating layers sufficiently thick and thin to avoid iridescence, it is possible to provide for the reflection to be essentially silver rather than iridescent. The silvery appearance is due to the fact that high-order reflections are so closely spaced that the human eye perceives the reflection as non-iridescent.

Multilayer reflective-interference polarizers made in accordance with the present invention exhibit a uniform silvery reflective appearance. The reflection characteristics of the disclosed multilayer reflective polarizer are governed by the equation (iii).

This equation indicates that the intensity Refl of the reflected light is a function of only rand k defined above. In a close approximation, Refl is a function of only the difference of refractive indices of the two adjacent layers and the total number of interfaces between layers. This relationship substantially differs from the case of interferential polarizers whose reflectivity is highly sensitive to the layer thickness and the angle of view.

Thus, the wavelength of light reflected from the multilayer reflective-interference polarizer is independent of the individual layer thicknesses and the total structure thickness over a wide range, provided that a substantial majority of the individual thick layers have an optical thickness equal to or greater than about 0.45 μm and that a substantial majority of the individual thin layers have an optical thickness equal to or less than about 0.09 μm. The uniformity of reflection is inherent in the proposed reflective polarizer. Moreover, a gradient of layer thickness across the reflective-interference polarizer structure is neither detrimental nor advantageous to the optical characteristics of the polarizer, provided that a substantial majority of the individual layers have optical thicknesses equal to or greater than about 0.45 μm and equal to or less than about 0.09 μm.

Therefore, it is not necessary for all layers in the reflective-interference polarizer of the present invention to have optical thicknesses equal to or greater than 0.45 μm and equal to or less than 0.09 μm. Variation in the thickness of each layer can be as large as 300% or even greater. However, useful reflective-interference polarizers can be obtained even with such large variations, provided that a substantial majority of the layers have optical thicknesses of not more than 0.09 μm and no less than 0.45 μm.

The reflective-interference polarizers according to the present invention exhibit better reflection of the incident light as the number of layers is increased.

The reflectivity of the reflective-interference polarizer also depends on the refractive index difference between the two materials used—the greater the difference in the refractive indices, the higher the reflectivity of the reflective-interference polarizer. Accordingly, the reflective nature of the polarizers can be controlled by selecting materials having substantially different refractive indices and by the designs which comprise additional layers.

In order that the invention may be more readily understood, reference is made to the following drawings, which are intended to be illustrative of the invention, but are not intended to be limiting in scope, in which:

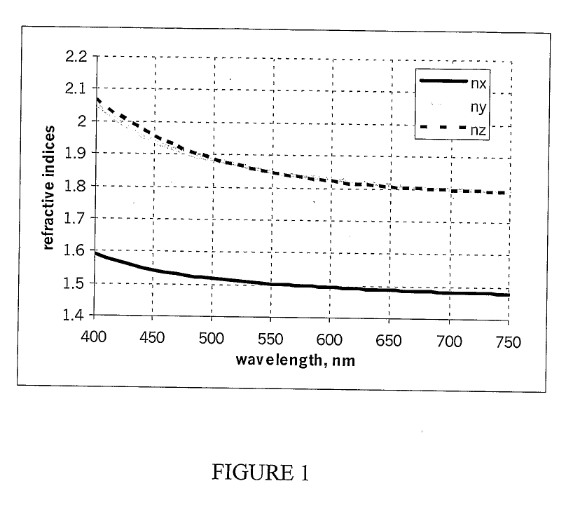

FIG. 1 shows refractive indices of the layer comprising a 6,7-dihydrobenzimidazo[1,2-c]quinazolin-6-one derivative;

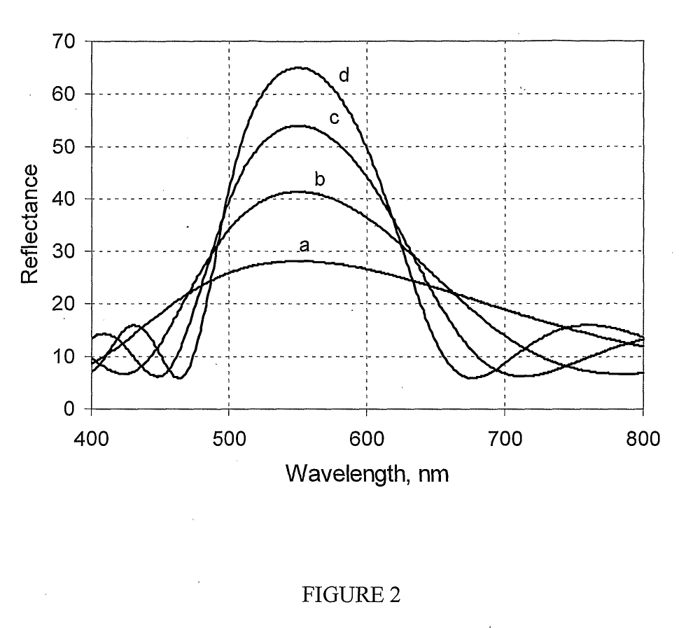

FIGS. 2 to 5 show simulated reflectance spectra with the polarizer reflectance as a function of the wavelength for a structure of one quarter-wave cavity, wherein the low index is fixed at 1.5, and the substrate refractive index is 1.52

FIG. 2 shows the polarizer reflectance as a function of the wavelength for the high index fixed at 1.8.

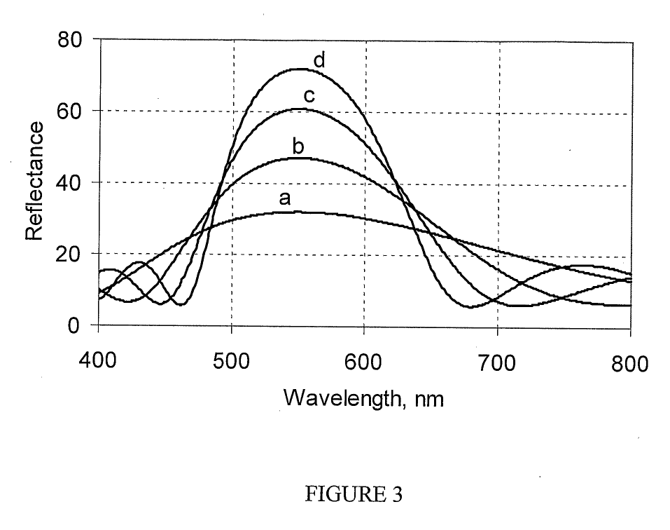

FIG. 3 shows the polarizer reflectance as a function of the wavelength for the high index fixed at 1.85.

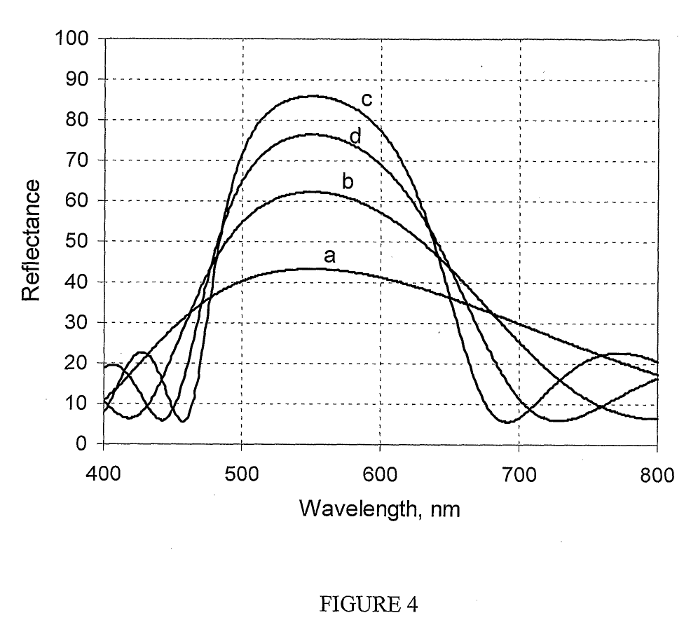

FIG. 4 shows the polarizer reflectance as a function of the wavelength for the high index fixed at 2.0.

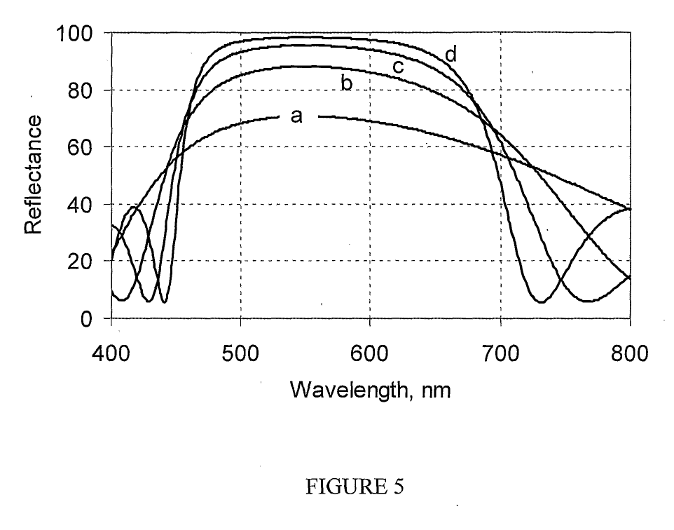

FIG. 5 shows the polarizer reflectance as a function of the wavelength for the high index fixed at 2.5.

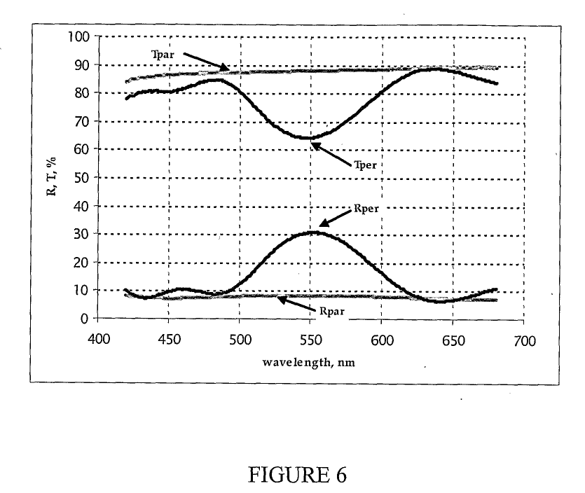

FIG. 6 shows experimental reflectance and transmittance spectra of a 5-layer interference cavity.

FIG. 1 shows refractive indices of layer made of a 6,7-dihydrobenzimidazo[1,2-c]quinazolin-6-one derivative containing carboxylic group and sulfonic group (see structural formula 20 given in Table 3).

Desired performance of the multilayer polarizers can be achieved by manipulating the refractive index and thickness of each individual layer and the total number of layers. One of the important aspects of the multilayer polarizer design is selection of the base structure. Typically, the broadband multilayer polarizer can be designed in the form of a periodic structure of double layers with high and low refractive indices in the plane of polarization of the incident light. The same pair of layers is repeatedly added until the performance is satisfactory. The structure is of the form: (HL)^{j-1} H, where H and L denote the high- and low-index layers, biaxial or uniaxial layer and isotropic clear lacquer respectively, and j is the number of pairs. Here, we refer to such a structure as a cavity, which contains a total of j high-index layers. The structure yields maximum reflection at a specific wavelength, when the optical thickness (physical thickness multiplied by refractive index) is equal to an odd number times a quarter of the light wavelength (quarter-wave thickness).

FIGS. 2-5 show the simulated reflectance spectra of a multilayer polarizer representing the case where the difference between high and low refractive indices in the plane of polarization is fixed at 0.3 and the number of high-index layers is varied from 2 to 5. Although designing a polarizer for a single wavelength is not the purpose, the result may provide some insight and guidelines for designing broadband reflectors.

FIG. 2 shows the polarizer reflectance as a function of the wavelength for a structure of one quarter-wave cavity containing 2, 3, 4, and 5H-layers (see the curves a, b, c and d respectively). The high index is fixed at 1.8 and the low index at 1.5, the substrate refractive index is 1.52. Therefore, FIG. 2 shows the effects of the number of layers on the performance of a system with such design. It is assumed that the materials are deposited onto a glass substrate having a refractive index of 1.5 and that light is incident from air, propagates through the multilayer structure, and exits from the substrate. The optical thickness is a quarter of 550 nm. With only 4 high-index layers, the reflectance can reach approximately 52%. As the number of layers increases, the reflectance grows dramatically, and falls more abruptly from high values to an oscillatory level. For example, if the number of high-index layers is increased to 7, then the polarizer reflectance becomes as high as 80%. Further increase in the number of high-index layers to 10 leads to an additional increase in the reflectance to approximately 93%.

It is necessary to note that the layer thickness may be too thin for accurate manufacturing control. In the visible wavelength range from 400 to 700 nm, the physical layer thickness is 55 to 97 nm for a refractive index of 1.8. The optical thickness can be increased to an odd number (e.g., 3 or 5) of quarter-wavelengths. However, increase in the layer thickness from 1 to 3 or 5 quarter-wavelengths decreases the bandwidth.

FIGS. 3-5 show the simulated reflectance spectrum of a multilayer polarizer representing the case where the difference between high and low refractive indices in the plane of polarization is fixed at 0.5-1 and the number of high-index layers is varied from 2 to 5.

FIG. 3 shows the polarizer reflectance as a function of the wavelength for a structure of one quarter-wave cavity containing 2, 3, 4, and 5H-layers (see the curves a, b, c and d respectively). The high index is fixed at 1.85 and the low index at 1.5, the refractive index of the substrate is 1.52.

FIG. 4 shows the polarizer reflectance as a function of the wavelength for a structure of one quarter-wave cavity containing 2, 3, 4, and 5H-layers (see the curves a, b, c and d respectively). The high index is fixed at 2.0 and the low index at 1.5, the refractive index of the substrate is 1.52.

FIG. 5 shows the polarizer reflectance as a function of the wavelength for a structure of one quarter-wave cavity containing 2, 3, 4, and 5H-layers (see the curves a, b, c and d respectively). The high index is fixed at 2.5 and the low index at 1.5, the refractive index of the substrate is 1.52. The comparison with FIG. 2 demonstrates that both the reflectance and bandwidth increase with increasing index contrast.

FIG. 6 shows experimental reflectance and transmittance spectra of a 5-layer interference cavity with the optical thickness of layers optimized to provide peak reflectance at 550 nm (indices' mismatch of 0.27). Transmission coefficients Tpar and Tper correspond to a light polarized in parallel and perpendicularly to coating direction respectively. The reflection coefficients Rpar and Rper correspond to a light polarized in parallel and perpendicularly to coating direction respectively. The 5-layer cavity was made using an organic compound with refraction indices shown in FIG. 1.

1-30. (canceled)

31. A multilayer polarizer comprising
a substrate and a plurality of layers located on the substrate, said substrate and plurality of layers being transparent in at least one predetermined wavelength subrange of the wavelength range from 200 to 2500 nm, and the layers are arranged in such a way that a light of first polarization is substantially reflected while a light of second polarization is substantially transmitted through the multilayer polarizer,
wherein at least one of said layers comprises rod-like supramolecules which form at least partially a three-dimensional structure in the layer.

32. A multilayer polarizer according to claim 31, wherein said rod-like supramolecules comprise at least one polycyclic organic compound with a conjugated π-system and functional groups which are capable of forming non-covalent bonds between said supramolecules.

33. A multilayer polarizer according to claim 31, wherein the at least one organic compound is heterocyclic.

34. A multilayer polarizer according to claim 31, wherein at least one of said layers is water non-soluble.

35. A multilayer polarizer according to claim 31, wherein at least one of said layers is optically biaxial.

36. A multilayer polarizer according to claim 31, wherein at least one of said layers is optically uniaxial.

37. A multilayer polarizer according to claim 31, wherein the rod-like supramolecules are oriented substantially parallel to the substrate surface.

38. A multilayer polarizer according to claim 31, wherein the rod-like supramolecules are oriented substantially perpendicular to the substrate surface

39. A multilayer polarizer according to claim 32, wherein at least one of the non-covalent bonds is a H-bond.

40. A multilayer polarizer according to claim 32, wherein at least one of the non-covalent bonds is a coordination bond.

41. A multilayer polarizer according to claim 32, wherein the organic compound has the general structural formula I 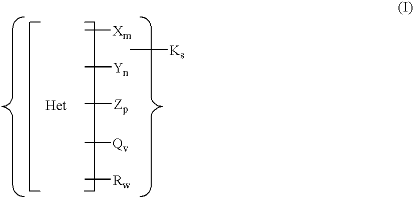
where Het is an at least partially conjugated planar heterocyclic molecular system,
X is a carboxylic group —COOH,
m is 0, 1, 2, 3 or 4;
Y is a sulfonic group —SO₃H,
n is 0, 1, 2, 3 or 4;
Z is an amide of a carboxylic acid group,
p is 0, 1, 2, 3 or 4;
Q is an amide of a sulfonic acid group,
v is 0, 1, 2, 3 or 4;
K is a counterion;
s is the number of counterions providing neutral state of the molecule;
R is a substituent selected from the list comprising CH₃, C₂H₅, NO₂, Cl, Br, F, CF₃, CN, OH, OCH₃, OC₂H₅, OCOCH₃, OCN, SCN, NH₂, and NHCOCH₃,
w is 0, 1, 2, 3 or 4,
wherein if the integer m is equal to 0, then both n and p are not equal to 0, and if the integer n is equal to 0, then the integer m is equal to or greater than 1.

42. A multilayer polarizer according to claim 41, wherein the counterion is selected from the list comprising H⁺, NH₄⁺, Na⁺, K⁺, Li⁺, Ba⁺⁺, Ca⁺⁺, Mg⁺⁺, Sr⁺⁺, Zn⁺⁺.

43. A multilayer polarizer according to claim 41, wherein Het has the general structural formula (II):

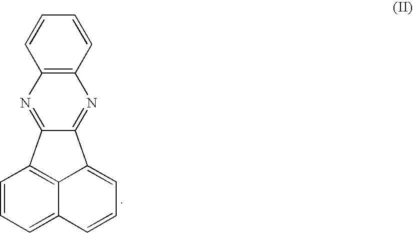

44. A multilayer polarizer according to claim 41, wherein Het has the general structural formula (III):

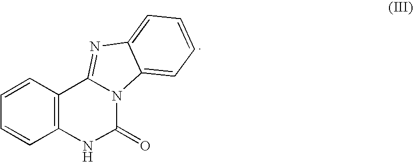

45. A multilayer polarizer according to claim 32, wherein the organic compound is an acenaphthoquinoxaline derivative.

46. A multilayer polarizer according to claim 45, wherein the acenaphthoquinoxaline derivative comprises a carboxylic group and has a general structural formula corresponding to one of structures 1-7:

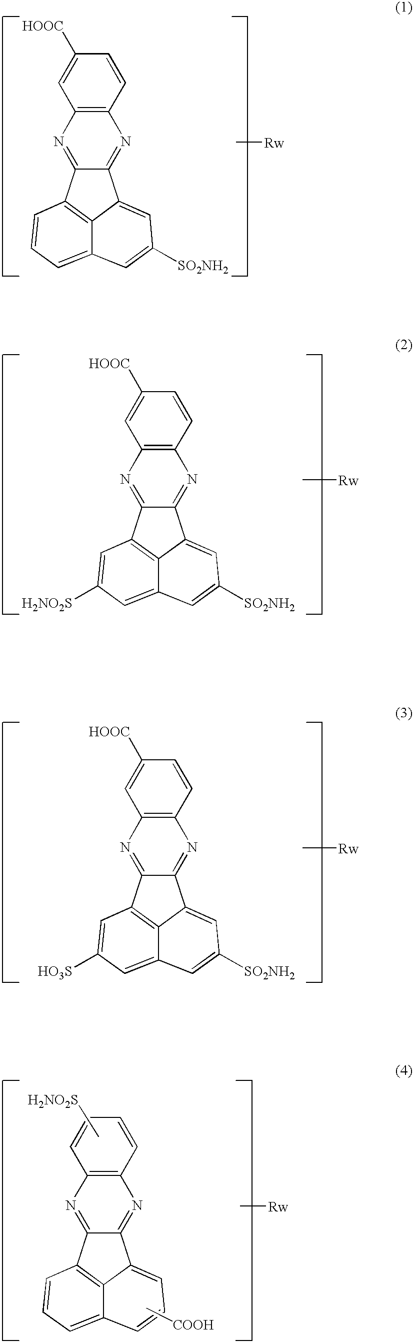

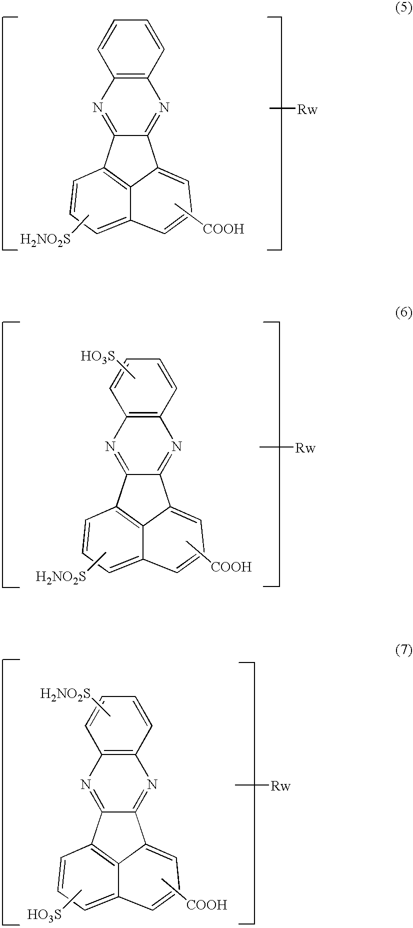

47. A multilayer polarizer according to claim 45, wherein the acenaphthoquinoxaline derivative comprises a sulfonic group and has a general structural formula corresponding to structures 8-19:

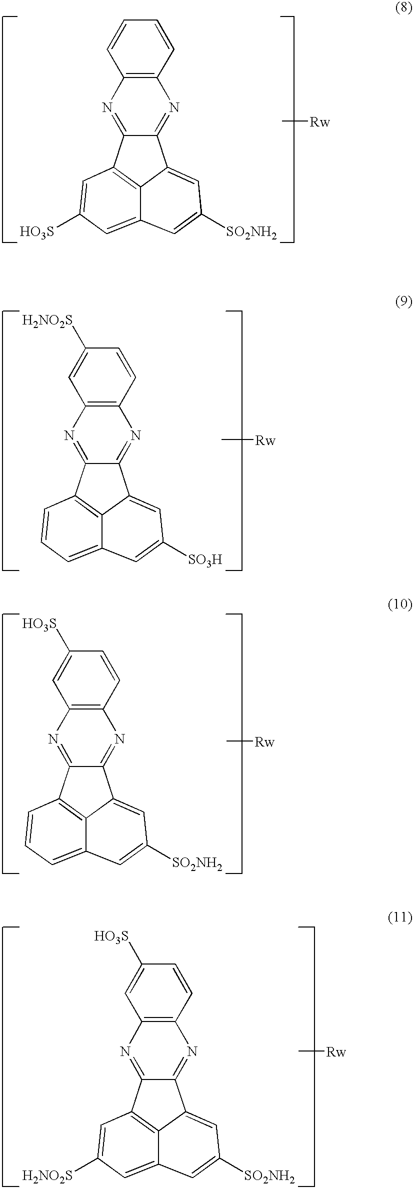

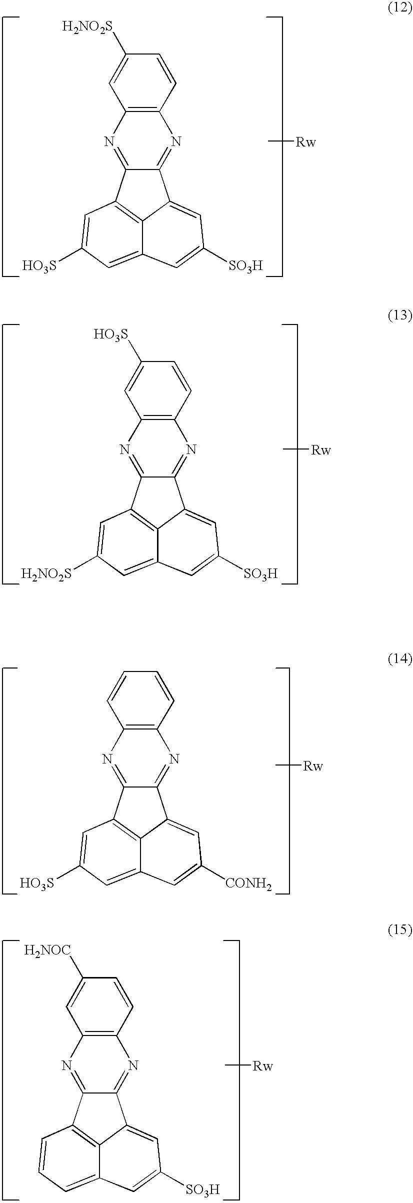

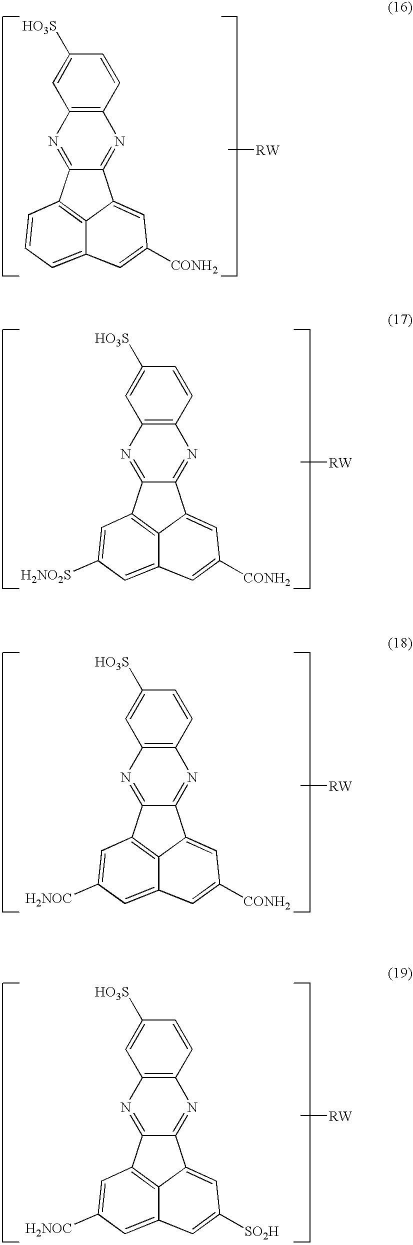

48. A multilayer polarizer according to claim 32, wherein the organic compound is a 6,7-dihydrobenzimidazo[1,2-c]quinazolin-6-one derivative.

49. A multilayer polarizer according to claim 48, wherein the 6,7-dihydrobenzimidazo[1,2-c]quinazolin-6-one derivative comprises at least one carboxylic group —COOH, the integer m is 1, 2 or 3, and said derivative has a general structural formula from the group comprising structures 20 to 32:

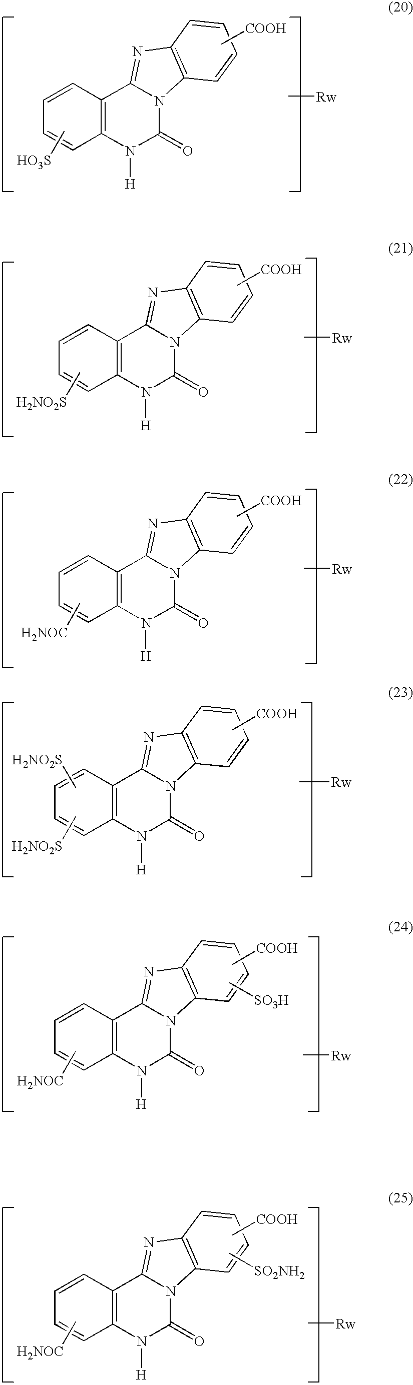

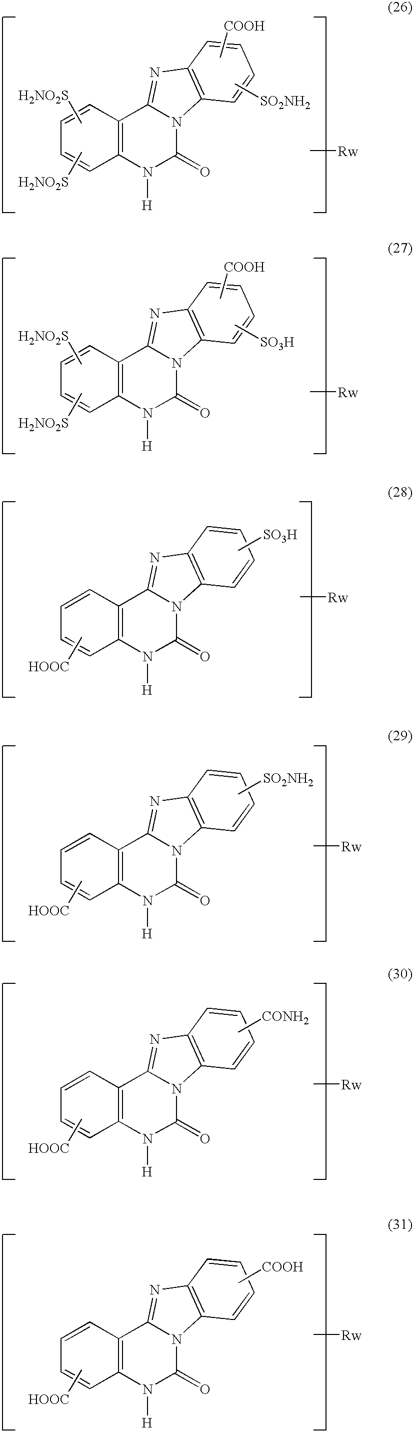

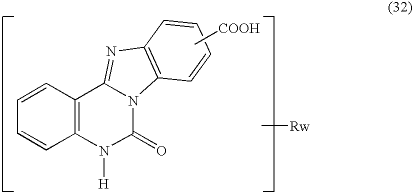

50. A multilayer polarizer according to claim 48, wherein the 6,7-dihydrobenzimidazo[1,2-c]quinazolin-6-one derivative comprises at least one said sulfonic group —SO₃H, the integer n is 1, 2 or 3, and said derivative has a general structural formula from the list comprising structures 33 to 41:

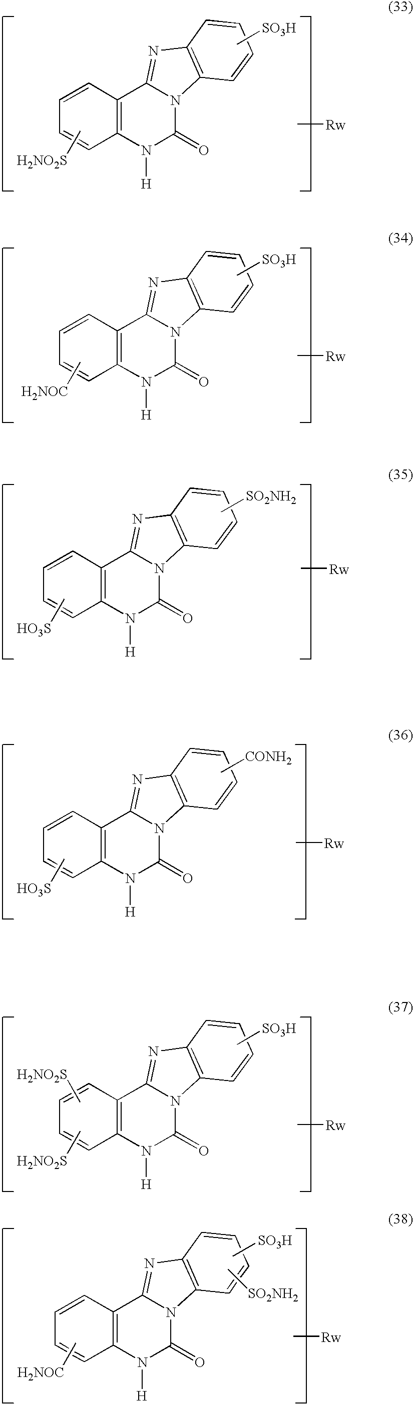

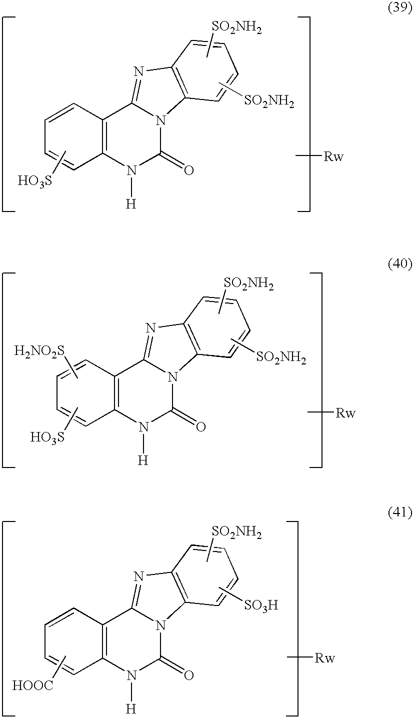

51. A multilayer polarizer according to claim 31, wherein said plurality of layers comprises a stack of alternating optically biaxial and isotropic layers.

52. A multilayer polarizer according to claim 31, wherein said plurality of layers comprises a stack of alternating optically uniaxial and isotropic layers.

53. A multilayer polarizer according to claim 51, wherein at least one isotropic layer comprises at least two sublayers made of materials having different indices of refraction.

54. A multilayer polarizer according to claim 31, wherein the plurality of layers is capable of polarizing light in the entire range of incident angles.

55. A multilayer polarizer according to claim 31, wherein the thickness of each layer is approximately equal to a quarter-wave and the total thickness of the plurality of layers does not exceed approximately 5 micrometers.

56. A multilayer polarizer according to claim 31, wherein the thickness of each layer is approximately equal to a quarter-wave and the total thickness of the plurality of layers does not exceed approximately 3 micrometers.

57. A multilayer polarizer according to claim 31, wherein a number of layers in the plurality of layers does not exceed 20.

58. A multilayer polarizer according to claim 31, wherein the number of layers does not exceed 10.

59. A multilayer polarizer according to claim 31, wherein the number of layers does not exceed 5.

60. A multilayer polarizer according to claim 32, wherein the rod-like supramolecules are formed by two or more of said polycyclic organic compounds.
